(19) United States
(12) Patent Application Publication
(10) Pub. No.: US 2007/0072967 A1
(43) Pub. Date: Mar. 29, 2007

(54) Polymeric molding compositions based on thermoplastic polyamides

(75) Inventors: Bernd Nass, Augsburg (DE); Sebastian Hoerold, Diedorf (DE); Ottmar Schacker, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH

(21) Appl. No.: 11/514,547

(22) Filed: Sep. 1, 2006

(30) Foreign Application Priority Data
Sep. 3, 2005 (DE) 10 2005 041 966.6

(51) Int. Cl. C08K 5/34; C08K 5/53

(52) U.S. Cl. 524/100; 524/126; 524/606

(57) ABSTRACT

Polymeric molding compositions based on thermoplastic polyamides, comprising, as component A, from 30 to 70% by weight of a thermoplastic polyamide, as component B, from 2 to 20% by weight of a phosphinic salt of the formula (I) and/or of a diphosphinic salt of the formula (II), and/or polymers of these, 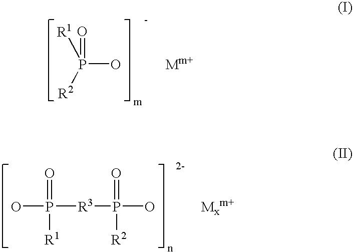 where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Ti, Zn, Fe, Zr, Ce, Bi, Sr, Mn, Li, Na, K, and/or a protonated nitrogen base; m is from 1 to 4; n is from 1 to 4; x is from 1 to 4, as component C, from 2 to 20% by weight of a nitrogen-containing synergist, or of a phosphorus/nitrogen flame retardant, as component D, from 5 to 60% by weight of a fibrous reinforcing material, as component E, from 2 to 30% by weight of a filler, as component F, from 0 to 5% by weight of an organic or inorganic zinc compound, or a mixture of various zinc compounds, and as component G, from 0 to 5% by weight of conventional additives and processing aids, where the entirety of components A to G always amounts to 100% by weight.

The present invention is described in the German priority application No. 102005041966.6, filed Mar. 9, 2005, which is hereby incorporated by reference as is fully disclosed herein.

The invention relates to polymeric molding compositions based on thermoplastic polyamides with high flame retardancy and with high glow-wire resistance, to their use, and to a process for their preparation.

Salts of phosphinic acids (phosphinates) have proven to be effective flame-retardant additives in particular for thermoplastic polymers (DE-A-2 252 258 and DE-A-2 447 727). Calcium phosphinates and aluminum phosphinates have been described as particularly effective in polyesters, and when compared with, for example, the alkali metal salts give less impairment of the properties of the polymer molding composition materials (EP-A-0 699 708).

Synergistic combinations of phosphinates with certain nitrogen-containing compounds have moreover been found, and in very many types of polymer are more effective as flame retardants than the phosphinates alone (PCT/EP 97/01664, and DE-A-197 34 437, and DE-A-197 37 727). DE-A-196 14 424 describes phosphinates in combination with nitrogen synergists in polyesters and in polyamides. Effective synergists described are inter alia melamine and melamine compounds, these themselves also having some degree of effectiveness in certain thermoplastics, but being markedly more effective in combination with phosphinates.

DE-A-1 99 33 901 describes phosphinates in combination with reaction products of melamine and phosphoric acid (phosphorus/nitrogen flame retardant), for example melamine polyphosphate, as a flame retardant for polyesters and polyamides. By using the flame retardants described in DE-A-1 99 33 901, it is possible to influence the stability of the polyamide during processing in the melt. Stability during processing can be markedly improved via addition of zinc compounds, such as zinc borate, zinc oxide, or zinc stearate (PCT/EP 03/09434).

According to PCT/EP 03/09434, it is also possible to improve processing stability by adding certain oxides, hydroxides, carbonates, silicates, borates, stannates, mixed oxide hydroxides, oxide hydroxide carbonates, hydroxide silicates, or hydroxide borates, or a mixture of these substances. Examples of compounds that can be used are magnesium oxide, calcium oxide, aluminum oxide, manganese oxide, tin oxide, aluminum hydroxide, boehmite, dihydrotalcite, hydrocalumite, magnesium hydroxide, calcium hydroxide, calcium carbonate, zinc hydroxide, tin oxide hydrate, or manganese hydroxide.

The effectiveness of the phosphinates and of the nitrogen synergists and, respectively, of the melamine-phosphoric acid reaction products as flame retardants is in essence described by using the UL 94 vertical fire test. However, for certain applications of polymeric molding compositions based on polyamides in the household equipment sector an important factor is performance in the IEC 60695-2-13 glow-wire test, high flame retardancy also being desirable. The combinations according to DE-A-1 99 33 901 are satisfactorily effective in polyamides with respect to the UL 94 vertical fire test, but effectiveness for certain applications remains unsatisfactory in the IEC 60695-2-13 glow-wire test.

It was therefore an object of the present invention to provide polymeric molding compositions which are based on thermoplastic polyamides and which simultaneously have high flame retardancy and high glow-wire resistance.

This object is achieved via polymeric molding compositions based on thermoplastic polyamides, in which phosphinates are used with nitrogen-containing synergists or with phosphorus/nitrogen flame retardants, with addition of glass fibers and talc, and, if appropriate, with addition of zinc compounds and of other additives. Polyamide molding compositions which have not only high flame retardancy but also high glow-wire resistance are advantageous for plastics producers, plastics compounders, or users, because it becomes possible to restrict the variety of grades to certain polyamide molding compositions or polyamide grades. This has in particular economic advantages: by way of example, cleaning times are not required and larger amounts of a uniform polyamide molding composition product can be manufactured, since there is no requirement for product change from one polyamide molding composition to another.

The invention therefore provides polymeric molding compositions based on thermoplastic polyamides, comprising,
as component A, from 30 to 70% by weight of a thermoplastic polyamide,
as component B, from 2 to 20% by weight of a phosphinic salt of the formula (I) and/or of a diphosphinic salt of the formula (II), and/or polymers of these, 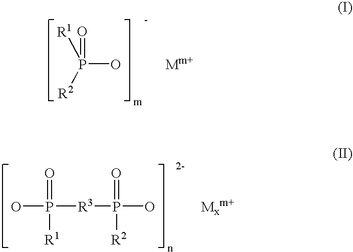
   where
R¹ and R² are identical or different and are C₁-C₆-alkyl, linear or branched, and/or aryl;
R³ is C₁-C₁₀-alkylene, linear or branched, C₆-C₁₀-arylene,
   -alkylarylene, or
   -arylalkylene;
M is Mg, Ca, Al, Sb, Sn, Ge, Ti, Zn, Fe, Zr, Ce, Bi, Sr, Mn, Li, Na, K, and/or a protonated nitrogen base;
m is from 1 to 4; n is from 1 to 4; x is from 1 to 4,
as component C, from 2 to 20% by weight of a nitrogen-containing synergist, or of a phosphorus/nitrogen flame retardant,
as component D, from 5 to 60% by weight of a fibrous reinforcing material,
as component E, from 2 to 30% by weight of a filler,
as component F, from 0 to 5% by weight of an organic or inorganic zinc compound, or a mixture of various zinc compounds,
as component G, from 0 to 5% by weight of conventional additives and processing aids,
   where the entirety of components A to G always amounts to 100% by weight.

The polyamides are preferably those of amino acid type and/or of diaminedicarboxylic acid type, and molding compositions are included which comprise polyamides which are obtainable via copolymerization or two or more monomers, or which comprise a mixture of two or more polyamides, the mixing ratio here being as desired.

The polyamides are preferably nylon-6, nylon-12, semiaromatic polyamides, and/or nylon-6,6, and molding compositions are included which comprise polyamides which are obtainable via copolymerization or two or more monomers, or which comprise a mixture of two or more polyamides, the mixing ratio here being as desired.

It is preferable that R¹ and R² of component B are identical or different and are C₁-C₆-alkyl, linear or branched, and/or phenyl.

It is preferable that R¹ and R² of component B are identical or different and are methyl, ethyl, n-propyl, isopropyl, n-butyl, tert-butyl, n-pentyl, and/or phenyl.

It is preferable that R³ of component B is methylene, ethylene, n-propylene, isopropylene, n-butylene, tert-butylene, n-pentylene, n-octylene or n-dodecylene; phenylene or naphthylene; methylphenylene, ethylphenylene, tert-butylphenylene, methyl-naphthylene, ethyinaphthylene or tert-butylnaphthylene; phenylmethylene, phenylethylene, phenylpropylene or phenylbutylene.

It is preferable that M of component B is Ca, Al or Zn.

It is preferable that component C is a nitrogen compound of the formulae (III) to (VIII) 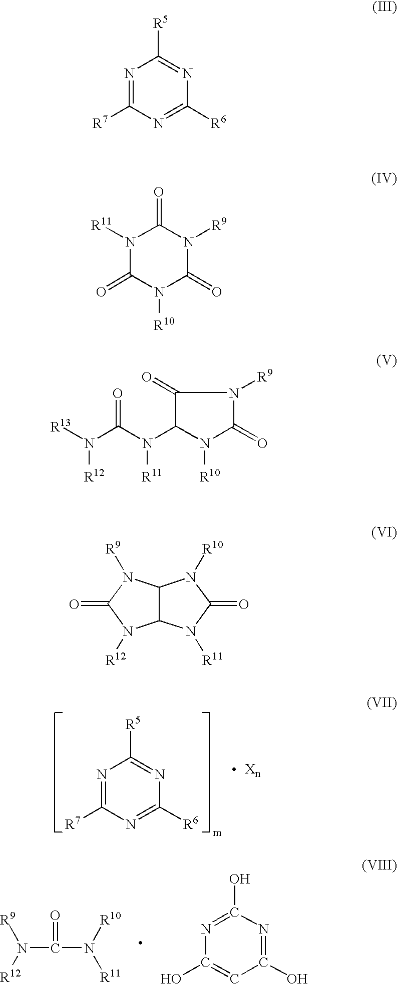
where
R⁵ to R⁷ are hydrogen, C₁-C₈-alkyl, or C₅-C₁₆-cycloalkyl or -alkylcycloalkyl, where appropriate substituted with a hydroxy function or with a C₁-C₄-hydroxyalkyl function, C₂-C₈-alkenyl, or C₁-C₈-alkoxy or -acyl or -acyloxy, or C₆-C₁₂-aryl or -arylalkyl, or —OR⁸ or —N(R⁸)R⁹, including systems of N-alicyclic or N-aromatic type,
R⁸ is hydrogen, C₁-C₈-alkyl, or C₅-C₁₆-cycloalkyl or -alkylcycloalkyl, where appropriate substituted with a hydroxy function or with a C₁-C₄-hydroxyalkyl function, C₂-C₈-alkenyl, or C₁-C₈-alkoxy or -acyl or -acyloxy, or C₆-C₁₂-aryl or -arylalkyl,
R⁹ to R¹³ are groups identical with R⁸ or else —O-R⁸,
m and n, independently of one another, are 1, 2, 3, or 4,
X are acids which can form adducts with triazine compounds (III), or are oligomeric esters of tris(hydroxyethyl) isocyanurate with aromatic polycarboxylic acids.

It is preferable that component C is benzoguanamine, tris(hydroxyethyl) isocyanurate, allantoin, glycoluril, melamine, melamine cyanurate, urea cyanurate, dicyandiamide and/or guanidine.

It is preferable that component C is condensates of melamine.

It is preferable that the condensates of melamine are melem, melam, melon and/or higher-condensation-level compounds thereof.

It is preferable that component C is reaction products of melamine with polyphosphoric acid and/or is reaction products of condensates of melamine with polyphosphoric acid, or is a mixture thereof.

It is preferable that the reaction products are dimelamine pyrophosphate, melamine polyphosphate, melem polyphosphate, melam polyphosphate, melon polyphosphate, and/or mixed polysalts of this type.

It is preferable that the reaction products are nitrogen-containing phosphates of the formulae (NH₄)_{y}H_{3-y}PO₄ or (NH₄PO₃)_{z}, where y is from 1 to 3 and z is from 1 to 10 000.

It is preferable that component C is melamine polyphosphate.

It is preferable that component D is carbon fibers, potassium titanate fibers, aramid fibers, natural fibers, glass textile, glass mats, and/or glass fibers.

It is preferable that the glass fibers are short glass fibers or continuous-filament strands (rovings).

It is preferable that component E is amorphous silica, barium sulfate, magnesium carbonate, calcium carbonate, kaolin, titanium dioxide, powdered quartz, mica, feldspar, wollastonite, silicates, and/or talc.

It is particularly preferable that component E is talc.

It is particularly preferable that component F is zinc oxide, zinc borate, zinc sulfide, zinc stearate and/or zinc montanate.

It is preferable that component G is additives and processing aids, such as pigments, dyes, waxes, nucleating agents, lubricants, mold-release agents, plasticizers, light stabilizers, other stabilizers, antioxidants, metal deactivators, antistatic agents, or a mixture of additives of this type.

The inventive polymeric molding compositions preferably comprise from 30 to 70% by weight of component A, from 2 to 20% by weight of component B, from 2 to 20% by weight of component C, from 5 to 60% by weight of component D, from 2 to 30% by weight of component E, from 0 to 5% by weight of component F, or a mixture thereof, and from 0 to 5% by weight of component G or a mixture thereof.

It is preferable that the inventive polymeric molding compositions comprise from 35 to 65% by weight of component A, from 3 to 18% by weight of component B, from 3 to 18% by weight of component C, from 10 to 35% by weight of component D, from 5 to 25% by weight of component E, from 0 to 3% by weight of component F, or a mixture thereof, and from 0 to 3% by weight of component G or a mixture thereof.

It is preferable that the inventive polymeric molding compositions comprise from 40 to 60% by weight of component A, from 4 to 15% by weight of component B, from 4 to 15% by weight of component C, from 15 to 30% by weight of component D, from 6 to 20% by weight of component E, from 0 to 2.5% by weight of component F, or a mixture thereof, and from 0 to 2.5% by weight of component G or a mixture thereof.

It is preferable that the inventive polymeric molding compositions comprise from 40 to 60% by weight of component A, from 4 to 15% by weight of component B, from 4 to 15% by weight of component C, from 15 to 30% by weight of component D, from 6 to 20% by weight of component E, from 0.1 to 2.5% by weight of component F, or a mixture thereof, and from 0.1 to 2.5% by weight of component G or a mixture thereof.

The invention also provides a process for preparation of polymeric molding compositions as claimed in one or more of claims 1 to 25, which comprises adding component A, B, C, and, if appropriate, E and F in a twin-screw extruder by way of the main or side feed, component D being added by way of a separate side feed.

The manner of conduct of the process can be such that two or more components B, C, and, if appropriate, E and Fare physically mixed prior to addition to the twin-screw extruder.

The invention also provides the use of the inventive polymeric molding compositions as claimed in one or more of claims 1 to 25 for production of, or in, moldings, films, filaments, or fibers.

The moldings are preferably used in the electrical industry.

The moldings are preferably switches or switch parts, contactors, circuit breakers, coil formers, plugs, multipoint connectors, fuse housings, and circuit-breaker housings.

Surprisingly, it has been found that inventive molding compositions composed of polyamides, of phosphinates, of nitrogen-containing synergists or of phosphorus-nitrogen flame retardants, glass fibers, and talc, and, if appropriate, of a zinc compound have improved glow-wire resistance simultaneously with high flame retardancy, whereas molding compositions composed of polyamides, of phosphinates, and of phosphorus/nitrogen flame retardants which also comprise only either glass fibers or talc and, if appropriate, comprise a zinc compound have either lower flame retardancy or lower glow-wire resistance.

As component A, the inventive molding compositions comprise from 30 to 70% by weight of the thermoplastic polyamide described by way of example in DE-A-1 99 20 276. The polyamides are preferably those of amino acid type and/or of diamine dicarboxylic acid type. The polyamides are preferably nylon-6, nylon-12, semiaromatic polyamides, and/or nylon-6,6. However, the molding compositions may also comprise polyamides obtainable via copolymerization of two or more monomers, or may comprise a mixture of two or more polyamides, the mixing ratio here being as desired.

Protonated nitrogen bases are preferably the protonated bases of ammonia, melamine, or triethanolamine, in particular NH₄⁺.

PCT/WO 97/39053 describes suitable phosphinates, and is expressly incorporated herein by way of reference.

Particularly preferred phosphinates are aluminum phosphinates, calcium phosphinates, and zinc phosphinates.

Examples of condensates of melamine are melem, melam, or melon or higher-condensation-level compounds of this type, and also mixtures of the same, and can, by way of example, be prepared via the process described in WO-A-96/16948.

The phosphorus/nitrogen flame retardants are preferably reaction products of melamine with phosphoric acid or with condensed phosphoric acids, or are reaction products of condensates of melamine with phosphoric acid or with condensed phosphoric acids, or else are mixtures of the products mentioned.

Reaction products of phosphoric acid or condensed phosphoric acids are compounds produced via reaction of melamine or of the condensed melamine compounds, such as melam, melem, or melon, etc., with phosphoric acid. Examples of these are dimelamine phosphate, dimelamine pyrophosphate, melamine phosphate, melamine pyrophosphate, melamine polyphosphate, melam polyphosphate, melon polyphosphate and melem polyphosphate, and/or the mixed polysalts described in WO 98/39306.

The inventive molding compositions comprise, as component D, from 5 to 60% by weight of a fibrous reinforcing material. Preferred fibrous reinforcing materials are carbon fibers, potassium titanate fibers, aramid fibers, natural fibers, glass textile, glass mats, and particularly preferably glass fibers. To improve compatibility with the thermoplastic polyamide, the glass fibers may have been equipped with surface modifications, such as a size and a coupling agent. These glass fibers incorporated can either take the form of short glass fibers or else take the form of continuous-filament strands (rovings). The diameter of the glass fibers used is in the range from 5 to 25 μm, and in the finished injection molding the average particle length of the glass fibers is in the range from 0.1 to 2 mm.

The inventive molding compositions comprise, as component E, from 2 to 30% by weight of a filler. Preferred fillers are amorphous silica, barium sulfate, magnesium carbonate, calcium carbonate, kaolin, titanium dioxide, powdered quartz, mica, feldspar, wollastonite, silicates, and particularly preferably talc. Talc is a hydrated magnesium silicate whose constitution is Mg₃[(OH)₂/Si₄O₁₀] or 3MgO 4SiO₂ H₂O. As a function of the type of talc, there may be admixtures present of chlorite, of dolomite, and of carbonates. To improve compatibility with the thermoplastic polyamide, the talc may have been equipped with a surface coating. The average particle size of the talc used is from 0.1 to 40 μm, preferably from 0.5 to 30 μm, particularly preferably from 1 to 20 μm.

The quantitative proportions of components A, B, C, D, E, F, and G in the polyamide molding composition are in essence dependent on the intended application sector and can vary widely, as described above.

The abovementioned additives and reinforcing materials (components B to G) can be introduced into the plastic in a very wide variety of steps of a process. For example, in the case of polyamides, mixing to incorporate additives and reinforcing materials into the polymer melt can take place as early as the start of the polymerization/polycondensation process or at its end, or in a subsequent compounding process, in conventional extruders or kneaders. Components B to G here can be added individually or by way of appropriate premixes. It is also possible to use, as component A, a pulverulent polyamide which, for example, has been obtained via milling and to blend this with components B to G appropriately prior to a further step of processing. There are also processing methods in which the addition of the additives and reinforcing materials is delayed until later. This practice is adopted in particular when using pigment masterbatches or additive masterbatches, which comprise appropriate additive materials in a suitable carrier material. It is also possible to apply in particular pulverulent additives in a drum mixer to the polymer pellets, which may have retained heat from the drying process.

The abovementioned additives and reinforcing materials (components B to G) preferably take the form of pellets, flakes, fiber, fine-grain material, powder, and/or micronizate.

Components B and C are preferably added in the form of a physical mixture of the solids, as a melt mixture, as a compactate, as an extrudate, or in the form of a masterbatch. Abovementioned components E and/or F and, if appropriate, G can optionally be incorporated previously into such mixtures.

The invention also provides moldings, films, filaments, and fibers produced from the inventive polyamide molding compositions, preferably moldings which are used in the electrical industry, for example as switches or switch parts, contactors, circuit breakers, coil formers, plugs, multipoint connectors, fuse housings, and circuit-breaker housings, etc.

### EXAMPLES

1. Components Used

Component A:

Nylon-6,6, pellets (Ultramid® A 3, uncolored, BASF AG, D)

Component B:

Aluminum diethylphosphinate, powder, hereinafter termed DEPAL

Component C:

Melamine polyphosphate, powder, hereinafter termed MPP (Melapur® 200, Ciba Melapur, NL)

Component D:

Glass fiber (Vetrotex® EC10 4.5 mm 983, St. Gobain Vetrotex, F)

Component E/1:

Talc, powder (Jetfine 3 C A, Luzenac Europe, F)

Component E/2:

Talc, powder (Luzenac 1445, Luzenac Europe, F)

Component F:

Zinc borate, powder (Firebrake® 500, U.S. Borax, USA)

2. Preparation, Processing, and Testing of Flame-retardant and Glow-wire-resistant Plastics Molding Compositions

The molding compositions were prepared in a corotating twin-screw extruder (Leistritz ZSE 27 HP 44 D) with a temperature profile of 280° C. at the main hopper falling to 255° C. at the extruder die, with a screw rotation rate of 250 rpm and a throughput of 20 kg per hour. The resultant melt temperature at the die under these conditions was about 280° C. Component A (PA 6.6 in the form of pellets) was added by way of the main feed, the pulverulent components B, C, E, and F were added by way of a first side feed unit, and component D (glass fibers) was added by way of a second side feed unit. If a plurality of components B, C, E, and F were added in an experimental mixture, these were physically mixed in a tumbling mixer prior to addition and then appropriately added. The ratio of the components processed was that stated in the tables. The homogenized polymer extrudate was drawn off, cooled in a water bath, and then pelletized.

After adequate drying, the molding compositions were processed in an injection molding machine (Arburg 320 C Allrounder) with a cylinder temperature setting of 270° C. at the feed to 300° C. at the nozzle and with a mold temperature of 80° C. to give test specimens, and were tested and classified on the basis of the UL 94 vertical test for flame retardancy and on the basis of the IEC 60695-2-13 standard for glow-wire resistance. The dimensions of the test specimens produced for the UL 94 test were 127 mm×12.7 mm×0.8 mm or 127 mm×12.7 mm×1.6 mm, and the dimensions of the test specimens produced for the glow-wire-resistance test were 60 mm×60 mm×1 mm or 60 mm×60 mm×2 mm.

Flame retardancy was determined on the basis of the UL 94 vertical test (Underwriters Laboratories Inc., Standard for Safety, Test for Flammability of Plastic Materials for Parts in Devices and Appliances, ISBN 0-7629-0082-2). This test is widely used in the electrical engineering sector and electrical application sector for assessing fire performance, and permits grading of the materials tested on exposure to an external source of ignition in the form of an open flame. The factors assessed are the afterflame times of the test specimens, and their afterglow performance and drip performance. If a flame retardant plastic is to be graded into class V-0, the following criteria have to be met: for a set of five test specimens, none of the specimens may have an afterflame time longer than 10 seconds after two flame applications of duration 10 seconds, using an open flame of defined height. The total of afterflame times for 10 flame applications to five specimens may not be greater than 50 seconds. Other criteria which have to be met are: no flaming drips, no complete consumption of the specimen, and total of afterflame time and afterglow time of each test specimen no longer than 30 seconds. Grading into class V-1 demands that the individual afterflame times are not longer than 30 seconds, and that the total of the afterflame times for 10 flame applications to five specimens is not greater than 250 seconds. Other criteria which have to be met are: no flaming drips, no complete consumption of the specimen, and total of afterflame time and afterglow time of each test specimen no longer than 60 seconds. Materials are graded into class V-2 in the event that flaming drips occur but the other criteria applicable for grading into class V-1 are met. If the above criteria are not met, the evaluation is n.c.=not classifiable as V-0, V-1, or V-2. Grading into class V-0 corresponds to high flame retardancy and is a requirement set for many applications in the electrical sector.

Glow-wire resistance was determined on the basis of IEC 60695-2-13. In this test, the value known as GWIT is determined. GWIT stands for glow-wire ignition temperature, and is a temperature higher by 25 K (30 K in the case of test temperatures from 900° C. to 960° C.) than the glow-wire-tip temperature at which no ignition occurs during a test on three test specimens of given thickness. Ignition is defined here as formation of a flame which lasts longer than five seconds. This test, too, is important in the electrical engineering and electronics applications sector, since in the event of a defect, for example a short circuit or overload, the temperatures reached by modules in electronic products can be high enough to ignite modules in the immediate vicinity of the current-carrying conductors. This behavior is represented in the glow-wire test. Part 30 “Resistance to heat and fire” of the “household appliances standard” IEC 60335-1 demands by way of example a GWIT to IEC 60695-2-13 of at least 775° C. in particular for unsupervised household devices and electrical currents greater than 0.2 A.

For reasons of comparability, identical conditions (temperature programs, screw geometries, injection molding parameters, etc.) were used for all of the experiments of each series. Prior to each test, the test specimens were stored for one week at 23° C. and 50% relative humidity.

Table 1 shows comparative examples of polyamide molding compositions based on PA 6.6 (component A), and if appropriate on aluminum diethylphosphinate (DEPAL; component B), and if appropriate on the phosphorus/nitrogen flame retardant melamine polyphosphate (MPP; component C), and if appropriate on zinc borate (component F), these comprising either glass fibers (component D) or talc (component E1 and, respectively, E2), or a combination of glass fibers and talc but no component B, C, or F. All amounts are stated as % by weight.

The results of the inventive examples in which polyamide molding compositions of the invention were manufactured (combination of component D with component E1 and, respectively, component E2 with simultaneous addition of components B, C, and F) have been listed in Table 2. All of the amounts are stated as % by weight.

Polyamides without addition of flame retardants have, as expected, only poor flame retardancy and low glow-wire resistance (comparative examples comp 1 to comp 5). From comparative examples comp 6 to comp 8 it can be seen that when glass fibers or talc are used alone in the polyamide molding compositions with flame retardants the result is either good flame retardancy (UL 94 vertical test class V-0) with inadequate glow-wire resistance (GWIT of 750° C.) or inadequate flame retardancy (UL 94 vertical test class V-1) with adequate glow-wire resistance (GWIT of 775° C.).

From inventive examples A1 and A2 it is apparent that the combination of glass fibers and talc in the polyamide molding compositions achieves not only high flame retardancy (UL 94 vertical test class V-0) but also high glow-wire resistance (GWIT of 775° C. or above) with constant total amount added of the flame retardants (components B and C.). This means that one and the same polyamide molding composition (inventive examples A1 and A2) can be used to cover a greater range of applications than is possible when using polyamide molding compositions of comparative examples comp 6, comp 7, or comp 8.

TABLE 1
Comparative examples (experimental series 1): polyamide molding compositions based on
PA 6.6 (component A), and if appropriate on aluminum diethylphosphinate (DEPAL; component
B), and if appropriate on the phosphorus/nitrogen flame retardant melamine polyphosphate
(MPP; component C), and if appropriate on zinc borate (component F), these comprising
either glass fibers (component D) or talc (component E1 and, respectively, E2), or a
combination of glass fibers and talc but no component B, C, or F.

| | | | | | | | | UL 94 vertical | GWIT/IEC |
|---|---|---|---|---|---|---|---|---|---|
| | A | B | C | D | E1 | E2 | F | test class | 60695-2-13 [° C.] |
| Comparison | [%] | [%] | [%] | [%] | [%] | [%] | [%] | (0.8 mm/1.6 mm) | (1 mm/2 mm) |
| comp1 | 70 | 0 | 0 | 30 | 0 | 0 | 0 | n.c.*/n.c. | 675/700 |
| comp2 | 70 | 0 | 0 | 0 | 30 | 0 | 0 | n.c./n.c. | 675/675 |
| comp3 | 70 | 0 | 0 | 0 | 0 | 30 | 0 | n.c./n.c. | 675/675 |
| comp4 | 70 | 0 | 0 | 20 | 10 | 0 | 0 | n.c./n.c. | 675/700 |
| comp5 | 70 | 0 | 0 | 20 | 0 | 10 | 0 | n.c./n.c. | 675/700 |
| comp6 | 52 | 11.4 | 5.7 | 30 | 0 | 0 | 0.9 | V-0/V-0 | 750/750 |
| comp7 | 52 | 11.4 | 5.7 | 0 | 30 | 0 | 0.9 | V-1/V-1 | 775/775 |
| comp8 | 52 | 11.4 | 5.7 | 0 | 0 | 30 | 0.9 | V-1/V-1 | 775/775 |

*n.c. = not classifiable as V-0, V-1, or V-2

TABLE 2
Inventive examples: polyamide molding compositions based on PA 6.6 (component
A), on aluminum diethylphosphinate (DEPAL; component B), on the phosphorus/nitrogen
flame retardant melamine polyphosphate (MPP; component C), and on zinc borate
(component F), these comprising not only glass fibers (component D) but
also talc (component E1 and, respectively, E2).

| | | | | | | | | | GWIT/IEC |
|---|---|---|---|---|---|---|---|---|---|
| | | | | | | | | UL 94 vertical | 60695-2-13 |
| Inventive | A | B | C | D | E1 | E2 | F | test class | [° C.] |
| example | [%] | [%] | [%] | [%] | [%] | [%] | [%] | (0.8 mm/1.6 mm) | (1 mm/2 mm) |
| A1 | 52 | 11.4 | 5.7 | 20 | 10 | 0 | 0.9 | V-0/V-0 | 775/800 |
| A2 | 52 | 11.4 | 5.7 | 20 | 0 | 10 | 0.9 | V-0/V-0 | 775/800 |

1. A polymeric molding composition based on thermoplastic polyamides, comprising,
as component A, from 30 to 70% by weight of at least one thermoplastic polyamide,
as component B, from 2 to 20% by weight of a phosphinic salt of the formula (I) of a diphosphinic salt of the formula (II), a polymer of the phosphinic salt of the formula (I), a polymer of a diphosphinic salt of the formula (II) or a mixture thereof, 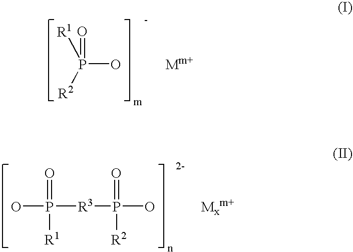
wherein
R¹ and R² are identical or different and are C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na, K, or a protonated nitrogen base;
m is from 1 to 4; n is from 1 to 4; x is from 1 to 4,
as component C, from 2 to 20% by weight of a nitrogen-containing synergist, or a phosphorus/nitrogen flame retardant,
as component D, from 5 to 60% by weight of a fibrous reinforcing material,
as component E, from 2 to 30% by weight of a filler,
as component F, from 0 to 5% by weight of an organic or inorganic zinc compound, or a mixture of various zinc compounds, and
as component G, from 0 to 5% by weight of at least one of one or more additives, one or more processing aids or both, where the entirety of components A to G always amounts to 100% by weight.

2. The polymeric molding composition as claimed in claim 1, wherein the at least one polyamide is of amino acid type.

3. The polymeric molding composition as claimed in claim 1, wherein the at least one polyamide is nylon-6, nylon-12, semiaromatic polyamides, nylon-6,6or mixtures thereof.

4. The polymeric molding composition as claimed in claim 1, wherein R¹ and R² of component B are identical or different and are C₁-C₆-alkyl, linear or branched, or phenyl.

5. The polymeric molding composition as claimed in claim 1, wherein R¹ and R² of component B are identical or different and are methyl, ethyl, n-propyl, isopropyl, n-butyl, tert-butyl, n-pentyl, or phenyl.

6. The polymeric molding composition as claimed in claim 1, wherein R³ of component B is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methyl-naphthylene, ethylnaphthylene, tert-butylnaphthylene, phenylmethylene, phenyl-ethylene, phenylpropylene or phenylbutylene.

7. The polymeric molding composition as claimed in claim 1, wherein M of component B is Ca, Al, or Zn.

8. The polymeric molding composition as claimed in claim 1, wherein component C is a nitrogen compound of the formulae (III) to (VIII) 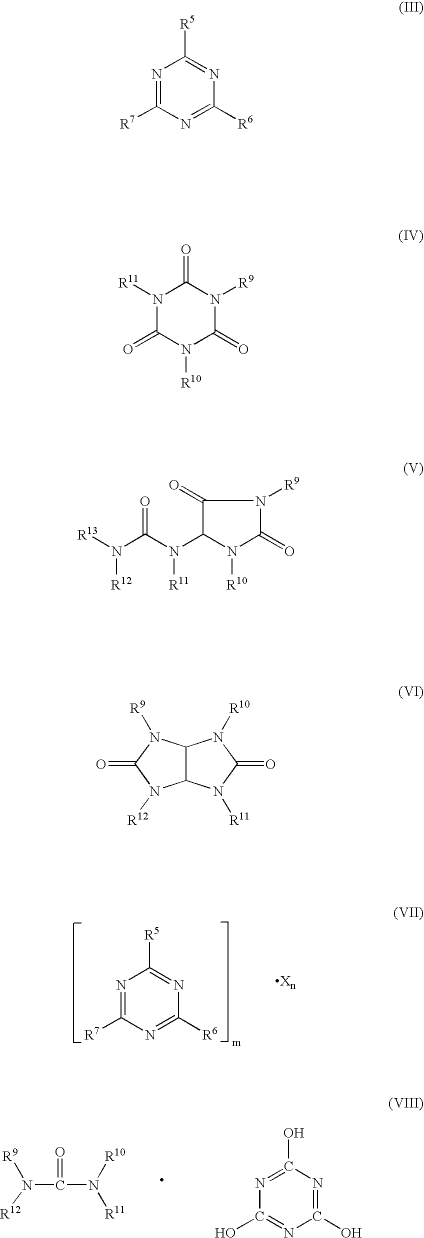
wherein
R⁵ to R⁷ are hydrogen, C₁-C₈-alkyl, C₅-C₁₆-cycloalkyl -alkylcycloalkyl, optionally substituted with a hydroxy function or with a C₁-C₄-hydroxyalkyl function, C₂-C₈-alkenyl, or C₁-C₈-alkoxy or -acyl or -acyloxy, or C₆-C₁₂-aryl or -arylalkyl; or —OR⁸ or —N(R⁸)R⁹, including systems of N-alicyclic or N-aromatic type,
R⁸ is hydrogen, C₁-C₈-alkyl, or C₅-C₁₆-cycloalkyl or -alkylcycloalkyl, optionally substituted with a hydroxy function or with a C₁-C₄-hydroxyalkyl function, C₂-C₈-alkenyl, or C₁-C₈-alkoxy or -acyl or -acyloxy, or C₆-C₁₂-aryl or -arylalkyl,
R⁹ to R¹³ are groups identical with R⁸ or —O-R⁸,
m and n, independently of one another, are 1, 2, 3, or 4,
X are acids which form adducts with triazine compounds (III), or are oligomeric esters of tris(hydroxyethyl) isocyanurate with aromatic polycarboxylic acids.

9. The polymeric molding composition as claimed in claim 1, wherein component C is benzoguanamine, tris(hydroxyethyl) isocyanurate, allantoin, glycoluril, melamine, melamine cyanurate, urea cyanurate, dicyandiamide, guanidine or a mixture thereof.

10. The polymeric molding composition as claimed in claim 1, wherein component C is a condensate of melamine.

11. The polymeric molding composition as claimed in claim 10, wherein the condensate of melamine is melem, melam, melons higher-condensation-level compounds thereof or mixture thereof.

12 The polymeric molding composition as claim 1, wherein component C is the reaction products of melamine with polyphosphoric acid, the reaction products of condensates of melamine with polyphosphoric acid, or a mixture thereof.

13. The polymeric molding composition as claimed in claim 12, wherein the reaction products are dimelamine pyrophosphate, melamine polyphosphate, melem polyphosphate, melam polyphosphate, melon polyphosphate, mixed polysalts thereof or a mixture thereof.

14. The polymeric molding composition as claimed in claim 13, wherein the reaction products are nitrogen-containing phosphates of the formulae (NH₄)_{y}H_{3-y}PO₄ or (NH₄P₃)_{z}, where y is from 1 to 3 and z is from 1 to 10 000.

15. The polymeric molding composition as claimed in claim 1, wherein component C is melamine polyphosphate.

16. The polymeric molding composition as claimed in claim 1, wherein component D is carbon fibers, potassium titanate fibers, aramid fibers, natural fibers, glass textile, glass mats, glass fibers or a mixture thereof.

17. The polymeric molding composition as claimed in claim 16, wherein the glass fibers are short glass fibers or continuous-filament strands.

18. The polymeric molding composition as claimed in claim 1, wherein component E is amorphous silica, barium sulfate, magnesium carbonate, calcium carbonate, kaolin, titanium dioxide, powdered quartz, mica, feldspar, wollastonite, silicates, talc or a mixture thereof.

19. The polymeric molding composition as claimed in claim 1, wherein component E is talc.

20. The polymeric molding composition as claimed in claim 1, wherein component F is zinc oxide, zinc borate, zinc sulfide, zinc stearate, zinc montanate or a mixture thereof.

21. The polymeric molding composition as claimed in claim 1, wherein component G is selected from the group consisting of pigments, dyes, waxes, nucleating agents, lubricants, mold-release agents, plasticizers, light stabilizers, stabilizers, antioxidants, metal deactivators, antistatic agents, and a mixture thereof.

22. The polymeric molding composition as claimed in claim 1, comprising from 30 to 70% by weight of component A, from 2 to 20% by weight of component B, from 2 to 20% by weight of component C, from 5 to 60% by weight of component D, from 2 to 30% by weight of component E, from 0 to 5% by weight of component F, and from 0 to 5% by weight of component G.

23. The polymeric molding composition as claimed in claim 1, comprising from 35 to 65% by weight of component A, from 3 to 18% by weight of component B, from 3 to 18% by weight of component C, from 10 to 35% by weight of component D, from 5 to 25% by weight of component E, from 0 to 3% by weight of component F and from 0 to 3% by weight of component G.

24. The polymeric molding composition as claimed in claim 1, comprising from 40 to 60% by weight of component A, from 4 to 15% by weight of component B, from 4 to 15% by weight of component C, from 15 to 30% by weight of component D, from 6 to 20% by weight of component E, from 0 to 2.5% by weight of component F and from 0 to 2.5% by weight of component G.

25. The polymeric molding composition as claimed in claim 1, comprising from 40 to 60% by weight of component A, from 4 to 15% by weight of component B, from 4 to 15% by weight of component C, from 15 to 30% by weight of component D, from 6 to 20% by weight of component E, from 0.1 to 2.5% by weight of component F and from 0.1 to 2.5% by weight of component G.

26. A process for preparation of polymeric molding compositions as claimed in claim 1, comprising the step of adding component A, B, C, and, optionally, E and F in a twin-screw extruder by a main or side feed, wherein component D is added by a separate side feed.

27. The process as claimed in claim 26, wherein two or more components B, C, and, if optionally, E and F are physically mixed prior to addition to the twin-screw extruder.

28. A polymeric article comprising a polymeric molding composition as claimed in claim 1, wherein the polymeric article is selected from the group consisting of moldings, films, filaments, and fibers.

29. The polymeric article as claimed in claim 28, wherein the molding is an electrical molding.

30. The polymeric article as claimed in claim 29, wherein the electrical molding is selected from the group consisting of switches, switch parts, contactors, circuit breakers, coil formers, plugs, multipoint connectors, fuse housings, and circuit-breaker housings.

31. The polymeric molding composition as claimed in claim 1, wherein the at least one polyamide is obtained by copolymerization of two or more monomers.

32. The polymeric article as claimed in claim 28, wherein the polymeric article is a film.

33. The polymeric article as claimed in claim 28, wherein the polymeric article is a filament.

34. The polymeric article as claimed in claim 28, wherein the polymeric article is a fiber.
